(19) United States
(12) Patent Application Publication
(10) Pub. No.: US 2006/0202832 A1
(43) Pub. Date: Sep. 14, 2006

(54) Floor mat for tracking and monitoring individuals

(76) Inventors: Dan Reznik, Plainsboro, NJ (US); Yan Lu, West Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/358,261

(22) Filed: Feb. 21, 2006

Related U.S. Application Data
(60) Provisional application No. 60/656,191, filed on Feb. 25, 2005.

(51) Int. Cl. G08B 13/14; G08B 1/08

(52) U.S. Cl. 340/572.7; 340/572.8; 340/539.1

(57) ABSTRACT

A floor mat for tracking and monitoring an individual comprises: an antenna, the antenna for forming an RFID reading zone; and a storage compartment, the storage compartment comprising: an RFID reader, the reader for driving the antenna and receiving information from an RFID tag; a microcontroller, the microcontroller for receiving the information received by the reader from the tag; a wireless networking module, the wireless networking module for establishing a wireless link with a neighboring mat or a computer and transmitting the information collected by the microcontroller; and a power supply, the power supply for providing power to the reader, microcontroller and wireless networking module.

### CROSS-REFERENCE TO RELATED APPLICATION

This application claims the benefit of U.S. Provisional Application No. 60/656,191, filed Feb. 25, 2005, a copy of which is herein incorporated by reference.

### BACKGROUND OF THE INVENTION

1. Technical Field

The present invention relates to tracking and monitoring, and more particularly, to a floor mat including an RFID reader for tracking and monitoring individuals in a facility.

2. Discussion of the Related Art

Physical tracking of inventory, raw materials, materials in manufacture, or other items and assets in a variety of locations, such as manufacturing facilities, libraries, offices or the like can be accomplished by using an RFID system. The basic RFID system consists of three components: an RFID reader (also known as an interrogator), an antenna or coil, which is driven by the reader, and a plurality of RFID tags (also known as transponders) pre-programmed with unique identifying information such as, for example, a 96-bit number.

In operation, the reader drives the antenna to emit radio signals for powering and achieving two-way communication with the tags. The coverage of radio frequency energy emitted by the antenna can range anywhere from one inch to hundreds of feet, depending upon the power output and radio frequency used. When an RFID tag passes through an active range of the reader's antenna, its internal circuitry is energized and its unique identifier is transmitted back to the reader using a suitable modulation technique and protocol. The reader then demodulates the identifier and passes it to a host computer to accomplish a monitoring task.

A significant advantage of the RFID system over, for example, bar code-based identification technology, is its non-contact (also known as non-line-of-sight) simultaneous read capability. For example, tags can be read through a variety of substances such as snow, fog, ice, paint, crusted grime, and other visually and environmentally challenging conditions, where barcodes or other optically read technologies would be useless. Further, a plurality of RFID tags can be read simultaneously at remarkable speeds, in most cases in a few milliseconds. As a result, RFID has tremendous potential for a wide range of automated data collection and identification applications that would not be possible otherwise.

Recently, RFFD has been used for the tracking of humans such as patients in a medical facility or inmates in a prison. In an exemplary patient tracking application, RFID tags with unique identification numbers are embedded into disposable wristbands given to patients at the time of their admission to a hospital. This offers the capability of following patients throughout a treatment's workflow and/or securely identifying them at various locations in the hospital, for example, by reading their wristbands with portable readers. In an exemplary security application, the movement and use of valuable equipment, resources and individuals can be monitored through RF tags attached to tools, computers, etc. or embedded in credit-card-size security badges.

One drawback associated with the tracking of humans is that the tag-reader communication is local (e.g., the range is short). Further, the interaction with the reader is transparent and thus not imperceptible. For example, when tracking patients via the scanning of wristbands by using High Frequency (HF) tags, whose range is in the tens of cm, with a range of 15cm being typical, time must be taken to scan a patient's wristband by means of a handheld device. Thus, in many cases, such as in the monitoring of the activity of elderly patients in the absence of staff, which can perform the scanning, it is desirable for an RFID system to coexist with the environment to enable the tracking and monitoring of moving individuals.

### SUMMARY OF THE INVENTION

The present invention provides a floor mat for tracking the movement and monitoring the status of individuals.

In one embodiment of the present invention, a floor mat comprises: an antenna, the antenna for forming an RFID reading zone; and a storage compartment, the storage compartment comprising: an RFID reader, the RFID reader for driving the antenna and receiving information from an RFID tag; a microcontroller, the microcontroller for receiving the information received by the RFID reader from the RFID tag; a wireless networking module, the wireless networking module for establishing a wireless link with a neighboring mat or a computer and transmitting the information collected by the microcontroller; and a power supply, the power supply for providing power to the RFID reader, controller and wireless networking module.

A range of the reading zone is determined according to a configuration of the antenna. The antenna is located in a stepping area of the mat and the storage compartment is located in a non-stepping area of the mat. The non-stepping area is located adjacent the stepping area. A height of the non-stepping area is greater than a height of the stepping area.

The RFID reader is one of a low, high or ultra-high frequency RFID reader. The wireless networking module transmits and receives data according to a ZigBee, Wifi or Bluetooth protocol. The power supply is a battery.

The floor mat further comprises a pressure sensor, the pressure sensor for measuring weight of an individual stepping on the mat. The storage compartment further comprises a self-localization module. The self-localization module is a wireless infrastructure module or a GPS module. The RFID tag is attached to an individual or an object.

In another embodiment of the present invention, a system for tracking and monitoring an individual comprises: a computer; and a plurality of mats in communication with the computer, each of the mats comprising: an antenna, the antenna for forming an RFID reading zone; and a storage compartment, the storage compartment comprising: an RFID reader, the RFID reader for driving the antenna and receiving information from an RFID tag attached to the individual; a microcontroller, the microcontroller for receiving the information received by the RFID reader from the RFID tag; a wireless networking module, the wireless networking module for establishing a wireless link with a neighboring mat or the computer and transmitting the information collected by the microcontroller; and a power supply, the power supply for providing power to the RFID reader, microcontroller and wireless networking module.

The information of the RFID tag includes a name of the individual, a location of the mat and a time the information was acquired. When the computer receives the information of the RFID tag, the computer stores the information. When the computer receives the information of the RFID tag, the computer displays the information for tracking movement of the individual.

The system further comprises a pressure sensor located in the stepping area for measuring weight of the individual stepping on the mat, wherein when the weight of an individual is measured, the weight of the individual is transmitted to the computer. When the computer receives the weight of the individual, the computer stores the weight of the individual for monitoring the weight of the individual.

The computer monitors a level of the power supply of each of the mats by transmitting a message to the mats requesting a status of the level of the power supply of each mat. When the level of the power supply of one of the mats is low, a nearby mat forms a wireless connection with the computer to maintain network integrity.

In yet another embodiment of the present invention, a floor mat for tracking movement of an individual in a facility comprises: an antenna located in a stepping area of the mat, the antenna for forming an RFID reading zone; and a storage compartment located in a non-stepping area of the mat, the storage compartment comprising: an RFID reader electrically connected to the antenna, the RFID reader for driving the antenna and receiving information from an RFID tag attached to the individual; a microcontroller electrically connected to the RFID reader, the microcontroller for receiving the information received by the RFID reader from the RFID tag; a wireless networking module electrically connected to the microcontroller, the wireless networking module for establishing a wireless link with a neighboring mat or a computer and transmitting the information collected by the microcontroller; and a power supply electrically connected to the RFID reader, microcontroller and wireless networking module, the power supply for providing power to the RFID reader, controller and wireless networking module.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 illustrates a walking-direction view and a top view of a mat for tracking and monitoring individuals according to an exemplary embodiment of the present invention;

FIG. 2 illustrates a walking-direction view and a lateral view of an RFID reader reading zone of the mat of FIG. 1;

FIG. 3 illustrates a multi-hop network of several mats of FIG. 1 in wireless communication with a host computer according to an exemplary embodiment of the present invention;

FIG. 4 illustrates a format for data transmission between a microcontroller in one of the mats and the host computer of FIG. 3; and

FIG. 5 illustrates a storage compartment of a mat for tracking and monitoring individuals according to another exemplary embodiment of the present invention.

### DETAILED DESCRIPTION OF EXEMPLARY EMBODIMENTS

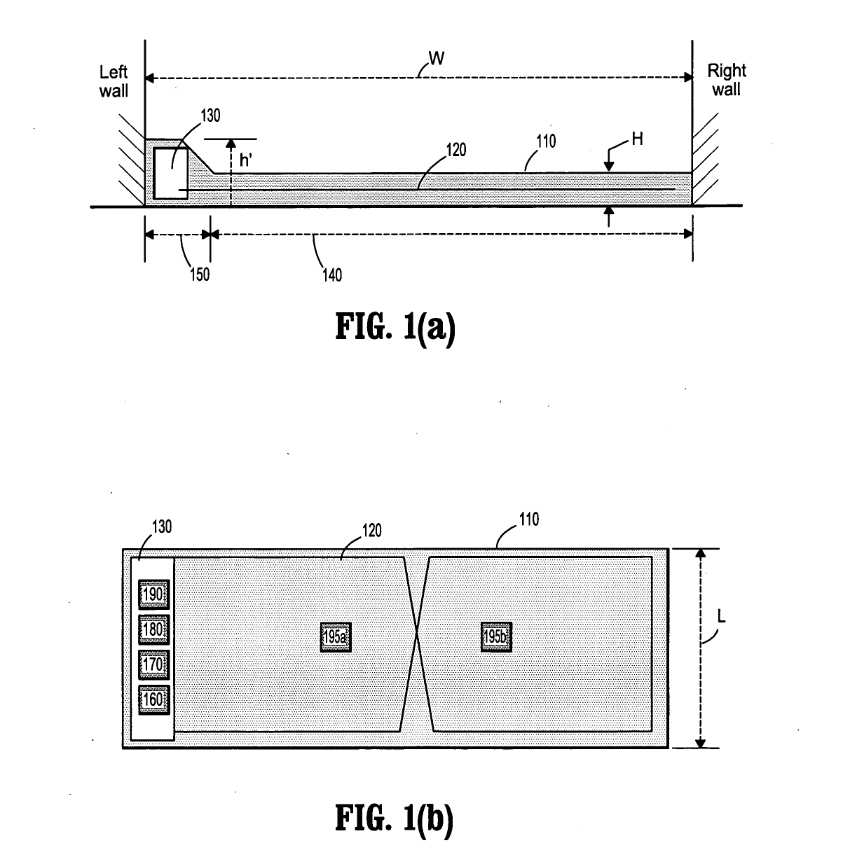

FIG. 1 illustrates a walking-direction view (a) and a top view (b) of a mat 110 for tracking and monitoring individuals according to an exemplary embodiment of the present invention.

As shown in FIG. 1, the mat 110 includes an antenna 120 such as a wire-loop or a dipole having suitable transmission and reception characteristics and a storage compartment 130 such as a rigid tube. The majority of the antenna 120 is located in a stepping area 140 of the mat 110 and the storage compartment 130 is located in a non-stepping area 150 of the mat 110. The antenna 120 could also be located in the storage compartment 130. In the top view (b) of FIG. 1, the storage compartment 130 includes an RFID reader 160, a microcontroller 170, a wireless networking module 180 and a power supply 190.

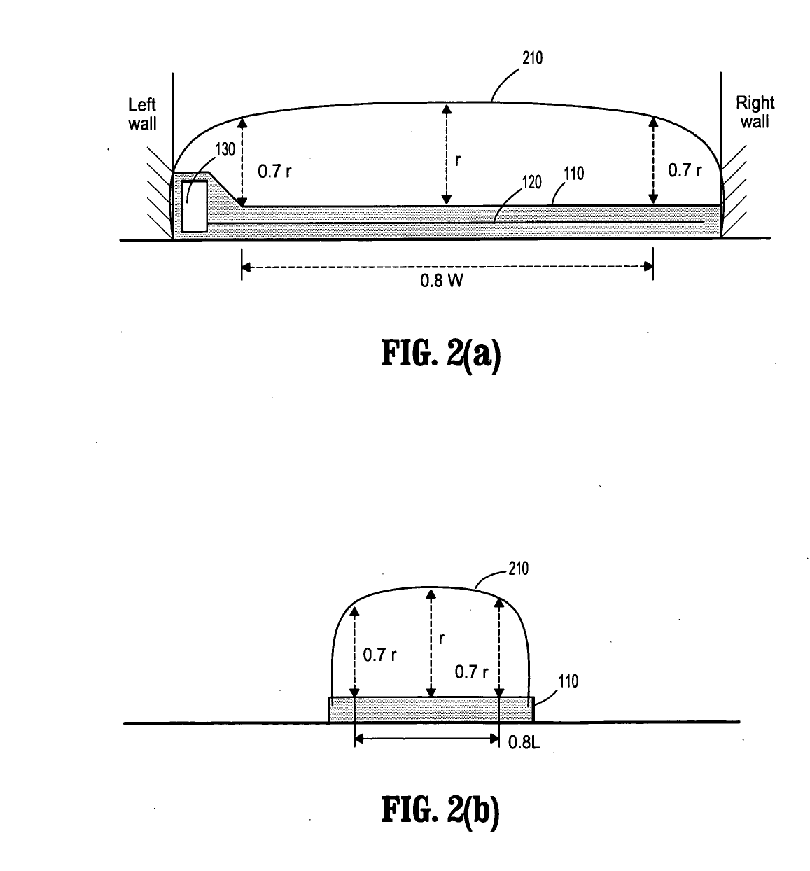

The RFID reader 160 is connected to the antenna 120. The RFID reader 160 is used to drive the antenna 120 to generate a reading zone for obtaining information from individuals and assets carrying RFID tags when they pass through the reading zone. The reading zone will be discussed in more detail hereinafter with reference to FIG. 2. The RFID reader 160 may be, for example, an HF (e.g., 13.56 MHz) unit such as the Skyetek M1 RFID reader that is complaint with an accepted RFID standard such as ISO/EC 15693.

The microcontroller 170 is connected to the RFID reader 160 (e.g., by a serial two-way communication means) and receives information collected by the RFID reader 160 from an RFID tag or tags that have passed through the reading zone. In addition, the microcontroller 170 may also be connected to sensors 195a and b located in the stepping area 140 for measuring temperature or mat pressure (or some other ambient variable). The measurement taken by the sensors 195a and b can be associated with the time an RFID tag crosses the reading zone. It is to be understood that since the location of the mat 110 is typically known and fixed, RFID reads by the reader 160 can be used to associate the presence of an individual at that particular location at a particular time.

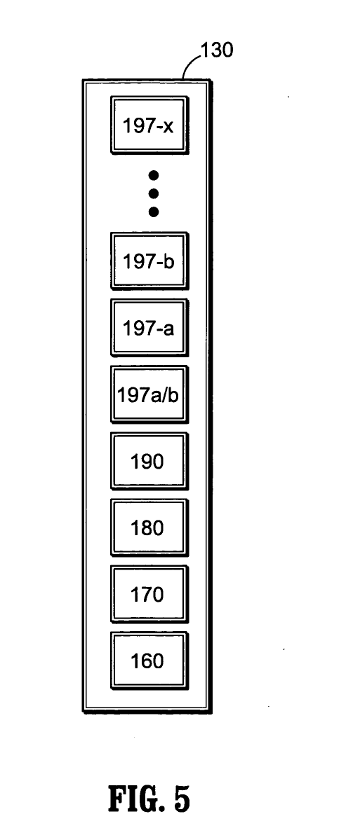

Although shown as being located in the stepping area 140, the sensors 195a and b could bellocated in the storage compartment 130 as shown, for example, in FIG. 5. When one of the sensors 195a or b is a pressure sensor used to measure weight of an individual stepping on the mat 110, a variation in a measured pressure or pressures could be used to turn on/off components in the storage compartment 130 or any other electronic components in the mat 110, thereby reducing power consumption. Further, the measured weight of an individual could be used in a health-maintenance application.

Because the mat 110 will typically be used as an embedded, stand-alone device, its electronic components should be low or ultra-low power. Thus, the microcontroller 170 could be, for example, the ultra-low power Texas Instruments MSP430 microcontroller.

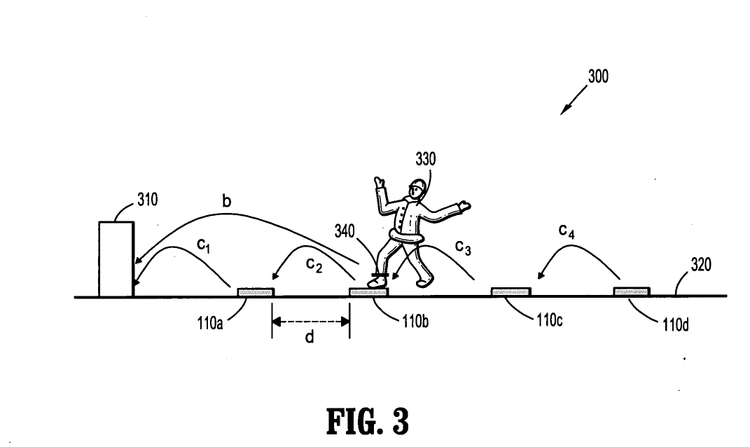

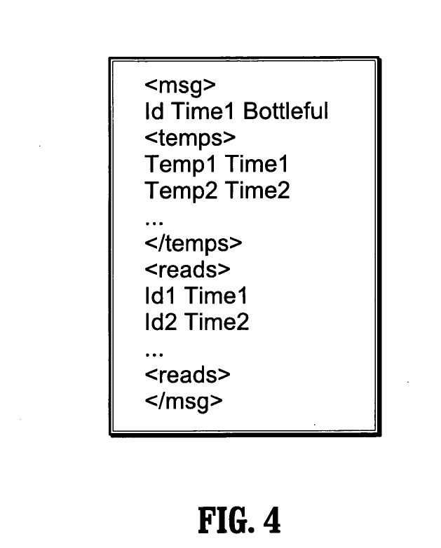

The wireless networking module 180 is connected to the microcontroller 170 and is used to establish ad-hoc links with neighboring mats or a direct connection to a host computer 310 as shown in FIG. 3. In other words, the wireless networking module 180 enables the mat 110 to communicate with other similarly equipped mats. In addition, automatic network configuration enables a plurality of mats 110 to be installed with minimal effort since network integrity could be established by an ad-hoc mesh protocol. Further, the wireless networking module 180 could also be used to establish a link with the host computer 310 so that information collected by the microcontroller 170 can be sent to the host computer 310 for analysis and network management purposes. These features will be discussed in more detail hereinafter with reference to FIGS. 3 and 4.

The wireless networking module 180 could be, for example, a low-power, high-range ZigBee compliant wireless networking module. In addition to ZigBee, the wireless networking module 180 could also be capable of transmitting data using WiFi or Bluetooth protocols.

The power supply 190 is connected to the RFID reader 160, microcontroller 170, wireless networking module 180 and/or sensors 195a and b and is used to provide power thereto. The power supply 190 may be, for example, a rechargeable lithium ion or lithium polymer battery capable of lasting a month or more without recharging. Power harvesting (e.g., from solar exposure or mat deformation) and power on/off management (e.g., triggered by pressure events) can also be used to achieve longer battery life.

Referring now to both the walking-direction view (a) and the top view (b) of FIG. 1, the mat 110 can be made to fit snug between two walls of a standard corridor having a width ‘W’ (e.g., about 150 cm). The mat 110 can also have a rectangular shape as shown and can be made of a waterproof, non-slippery material (e.g., a flexible/deformable plastic such as vinyl or polyurethane). In addition, a length ‘L’ of the mat 110 could be a multiple of one to three times that of a human foot. Further, to make the mat 110 imperceptible to a walking subject, the stepping area 140 should have a small thickness ‘H’ (e.g., between 1-2 cm). The thickness ‘H’ of the stepping area 140 could be less than a thickness ‘h’ of the non-stepping area 150.

It is to be understood however that the mat 110 is not limited to the configurations illustrated in FIG. 1. For example, the mat 110 does not have to fit snug across a corridor, nor does the non-stepping area 150 have to have a thickness greater than a thickness of the stepping area 140. The mat 110 could be made large enough to accommodate a load such as that of a truck. In addition, the storage compartment 130 does not have to be a rigid tube. Instead, the storage compartment 130 could be in the shape of a rectangular box or simply a secure area that stores the electronic components of the mat 110 in a secure manner. The storage compartment 130 could also be located in the stepping area 140.

It should also be understood that the mat 110 can be placed inside a rug or embedded in a walking or running environment such as the floor of a building or a racetrack. Moreover, the mat 110 can be designed such that recharging plugs to the power supply 190 are accessible from, for example, the non-stepping area 150 and that the electronic components found in the storage compartment 130 are accessible for maintenance and upgrading. For example, the non-stepping area 150 can have a zipper with a lock or a keyhole at an opening for enabling simple yet secure access to the storage compartment 130.

In addition, although the mat 110 has been described as including a stepping area 140 and a non-stepping area 150, it is to be understood that these terms are merely used for descriptive purposes. For example, the non-stepping area 150 does not mean that it can not be stepped on, it is simply descriptive of an area of the mat 110 that is not typically stepped on by as passer-by since it is typically located near an edge of the mat 110 adjacent to a wall.

The RFID reading zone will now be described with reference to FIG. 2. FIG. 2 illustrates a walking-direction view (a) and a lateral view (b) of an RFID reader zone 210 of the mat 110. As shown in FIG. 2, when the antenna 120 is configured as shown in FIG. 1, the reading zone 210 becomes, for example, a 3D bean shaped region. Thus, as shown in either the walking-direction view (a) or the lateral view (b), a middle point of the region is sensitive to an RFID tag passing within a distance ‘r’ (e.g., 15 cm) above the mat 110. As further shown in the walking-direction and lateral views (a and b), the reading zone 210 tapers off so that an active height thereof is 0.7 r (e.g., 10.5 cm) for at least 80% of the mat 110.

It is to be understood that the configuration of the antenna 120 is used to determine the range of the reading zone 210. Thus, if the antenna 120 runs adjacent to the edges of the mat 110, the reading zone 210 would be more sensitive at the edges and less sensitive in the center of the mat 110. On the contrary, if the antenna 120 forms a crisscross in the center of the mat 110, the reading zone 210 would be much more sensitive at the center of the mat 110 than near the edges.

FIG. 3 illustrates a configurable network 300 of several mats 110a-d in wireless communication with a host computer 310 according to an exemplary embodiment of the present invention.

As shown in FIG. 3, the mats 100a-d, each of which has the same or similar configuration as the mat 110 of FIG. 1, are positioned at nearly regular intervals ‘d” along a passageway 320 such as a building corridor or a pedestrian walking path. It is to be understood that the length of the intervals ‘d’ could be, for example, up to 100 m or as little as 5 m as the length of the intervals ‘d’ depends on the wireless transmission capability of the wireless networking modules 180 used by the mats 100a-d.

The topology of the network 300 is such that it is self-configurable based on the availability of mats. For example, if all four mats 110a-d are fully-operational, wireless links ‘C₂-C₄’ are established among consecutive mats and a wireless link ‘C₁’ is established between a mat nearest the host computer 310. In other words, link ‘C₄’ is established between mats 110d and c, link ‘C₃’ is established between mats 110c and b, link ‘C2’ is established between mats 110b and c and link ‘C₁’ is established between mat 110a and the host computer 310.

The network 300 may also be self-healing. For example, if one of the mats 110a-d such as mat 110a is temporarily unavailable due, for example, to a loss of power, a link ‘b’ may be established between a nearby mat such as mat 110b and the host computer 310. To reduce the likelihood that the mats 110a-d may become orphaned, the host computer 310 can be strategically located, for example, in a central location to the mats 110a-d.

When monitoring the network 300, the microcontroller 170 in each mat 110a-d can gather one temperature or pressure sample per second and ten RFID samples per second. The duty cycle of both operations can be adjusted to reduce power consumption. At, for example, every ten seconds, the data acquired by the microcontroller 170 can be transmitted across the network 300 to a wireless networking module (not shown) of the host computer 310. The host computer 310, which may include a basic reporting program, may then be used display a log of the received data. An exemplary format of the data transmitted from the mats 110a-d to the host computer 310 is shown in FIG. 4.

As shown in FIG. 4, the components of a message between <msg> and </msg> include a header containing an ID of the mat 110, the time the message was sent and the battery level of the mat 110, followed by a list of temperatures measured since the last message. This list may be surrounded by <temps> and </temps> markers. Each entry in this list is a temperature/time-of-measurement pair. Next, is a list of RFID reads, delimited by <reads> and </reads> brackets. Each entry in this list includes a unique ID, which was read since the last transmission, timestamped with the time at which the ID was read.

Thus, for example, when an individual 330 wearing an ankle bracelet 340 with an RFID tag steps on the mat 110b as shown in FIG. 3, the unique ID read from the RFID tag is included on this list to be transmitted to the host computer 310. This information may then be used by the host computer 310 to track and/or monitor the individual 330 because the fixed location of each mat 110a-d is presumably recorded at the time of installation.

In yet another embodiment of the present invention illustrated in FIG. 5, each mat 110a-d could be equipped with an autonomous means of self-localization, such as a wireless infrastructure module 197a for real-time location or a GPS sensor module 197b. Although the modules 197a and 197b are shown as being located in the storage compartment 130, they may also be located outside of the storage compartment 130 similar to the sensors 195a and b shown in view (b) of FIG. 1. Further, although the modules 197a and 197b are described as being used for self-localization, the modules 197a-x may be used for any of the functions described herein.

Referring back to FIG. 3, it is to be understood that the host computer 310 can also issue a command to each of the mats 110a-d which tests the integrity/availability of the mats 110a-d, determines the battery level of the mats 110a-d, sets the time of the mats 110a-d (e.g., global synchronization) and changes the sampling parameters for temperature, RFID reads and messaging frequency. Further, each of the mats 110a-d can have a unique ID (e.g., specified at the message's header) that allows for each of the mats 110a-d to be probed and correctly identified.

According to an exemplary embodiment of the present invention, a plurality of self-contained floor mats can be used to track the movement and monitor the status of a number of individuals in a facility in an essentially imperceptible manner. In addition to tracking and monitoring patients and staff in a medical facility such as a hospital or nursing home, the mats can be used in a variety of other facilities such as health clubs or warehouses. For example, the mats could be placed in or on a race track of a health club, park or walking path to monitor the speed at which an individual runs or walks around the track. In addition, the mats could be placed in a warehouse or port to track the movement of certain objects such as inventory or to monitor the weight of a cargo container. Further, the mats could be integrated with voice-based technologies and warehouse management systems for allocation of tasks based on optimization of criteria.

It should be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A floor mat, comprising:
an antenna, the antenna for forming an RFID reading zone; and
a storage compartment, the storage compartment comprising:
an RFID reader, the RFID reader for driving the antenna and receiving information from an RFID tag;
a microcontroller, the microcontroller for receiving the information received by the RFID reader from the RFID tag;
a wireless networking module, the wireless networking module for establishing a wireless link with a neighboring mat or a computer and transmitting the information collected by the microcontroller; and
a power supply, the power supply for providing power to the RFID reader, controller and wireless networking module.

2. The floor mat of claim 1, wherein a range of the reading zone is determined according to a configuration of the antenna.

3. The floor mat of claim 1, wherein the antenna is located in a stepping area of the mat and the storage compartment is located in a non-stepping area of the mat.

4. The floor mat of claim 3, wherein the non-stepping area is located adjacent the stepping area.

5. The floor mat of claim 3, wherein a height of the non-stepping area is greater than a height of the stepping area.

6. The floor mat of claim 1, wherein the RFID reader is one of a low, high or ultra-high frequency RFID reader.

7. The floor mat of claim 1, wherein the wireless networking module transmits and receives data according to a ZigBee, Wifi or Bluetooth protocol.

8. The floor mat of claim 1, wherein the power supply is a battery.

9. The floor mat of claim 1, further comprising:
a pressure sensor, the pressure sensor for measuring weight of an individual stepping on the mat.

10. The floor mat of claim 1, wherein the storage compartment further comprises:
a self-localization module.

11. The floor mat of claim 10, wherein the self-localization module is a wireless infrastructure module or a GPS module.

12. The floor mat of claim 1, wherein the RFID tag is attached to an individual or an object.

13. A system for tracking and monitoring an individual, comprising:
a computer; and
a plurality of mats in communication with the computer, each of the mats comprising:
an antenna, the antenna for forming an RFID reading zone; and
a storage compartment, the storage compartment comprising:
an RFID reader, the RFID reader for driving the antenna and receiving information from an RFID tag attached to the individual;
a microcontroller, the microcontroller for receiving the information received by the RFID reader from the RFID tag;
a wireless networking module, the wireless networking module for establishing a wireless link with a neighboring mat or the computer and transmitting the information collected by the microcontroller; and
a power supply, the power supply for providing power to the RFID reader, microcontroller and wireless networking module.

14. The system of claim 13, wherein the information of the RFID tag includes a name of the individual, a location of the mat and a time the information was acquired.

15. The system of claim 14, wherein when the computer receives the information of the RFID tag, the computer stores the information.

16. The system of claim 14, wherein when the computer receives the information of the RFID, the computer displays the information for tracking movement of the individual.

17. The system of claim 13, further comprising:
a pressure sensor located in the stepping area for measuring weight of an individual stepping on the mat, wherein when the weight of the individual is measured, the weight of the individual is transmitted to the computer.

18. The system of claim 17, wherein when the computer receives the weight of the individual, the computer stores the weight of the individual for monitoring the weight of the individual.

19. The system of claim 13, wherein the computer monitors a level of the power supply of each of the mats by transmitting a message to the mats requesting a status of the level of the power supply of each mat.

20. The system of claim 19, wherein when the level of the power supply of one of the mats is low, a nearby mat forms a wireless connection with the computer to maintain network integrity.

21. A floor mat for tracking movement of an individual in a facility, comprising:
an antenna located in a stepping area of the mat, the antenna for forming an RFID reading zone; and
a storage compartment located in a non-stepping area of the mat, the storage compartment comprising:
an RFID reader electrically connected to the antenna, the RFID reader for driving the antenna and receiving information from an RFID tag attached to the individual;
a microcontroller electrically connected to the RFID reader, the microcontroller for receiving the information received by the RFID reader from the RFID tag;
a wireless networking module electrically connected to the microcontroller, the wireless networking module for establishing a wireless link with a neighboring mat or a computer and transmitting the information collected by the microcontroller; and
a power supply electrically connected to the RFID reader, microcontroller and wireless networking module, the power supply for providing power to the RFID reader, controller and wireless networking module.
